(19) United States
(12) Patent Application Publication
(10) Pub. No.: US 2009/0257118 A1
(43) Pub. Date: Oct. 15, 2009

(54) BEAM-SHAPING TELESCOPE

(76) Inventors: JEAN-MARC HERITIER, Sunnyvale, CA (US); Rimas Viselga, Sunnyvale, CA (US)

Correspondence Address: Coherent, Inc. c/o Morrison & Forester, 425 Market Street, San Francisco, CA, 94105-2482, US

(21) Appl. No.: 12/103,097

(22) Filed: Apr. 15, 2008

(51) Int. Cl. G02B 23/00

(52) U.S. Cl. 359/399; 359/366

(57) ABSTRACT

A beam shaping telescope includes two mirrors having rotationally symmetric curvature inclined to the optical axis of the telescope. By selecting an appropriate curvature, spacing, and inclination of the mirrors, the telescope can be used to transform an astigmatic laser beam having a non-circular cross section into a circular beam having essentially zero astigmatism.

### PRIORITY

This application claims priority to U.S. Provisional Application 60/693,820, filed Aug. 7, 2007, the disclosure of which is incorporated herein by reference.

### TECHNICAL FIELD OF THE INVENTION

The present invention relates in general to optical arrangements for projection of laser beams. The invention relates in particular to a telescope for transforming a non-circular astigmatic laser beam into a circular anastigmatic beam.

### DISCUSSION OF BACKGROUND ART

Certain laser systems such as amplified seed laser systems have a gain-medium medium that is astigmatic, i.e., an amplified beam delivered by the laser system is generally astigmatic. This astigmatism results in the output beam being generally elliptical, with a major-axis to minor-axis ratio that varies progressively with distance. In many applications of laser beams it is necessary to focus the beam to a minimum possible spot-size. If a conventional projection lens or telescope is used to focus an astigmatic beam it will be found that the beam can only be focused in only one of two planes perpendicular to each other. These planes are usually referred to as the tangential and sagittal plane by practitioners of the optical design art. There will be, in effect, different sagittal and tangential focal distances. As certain factors that lead to the astigmatism are ephemeral, the astigmatism can vary from laser to laser in manufacturing lasers that are nominally identical.

It is possible to correct an astigmatic condition by using a beam-shaping optical arrangement to correct both the elliptical shape of beam and the astigmatism. Arrangements including cylindrical or anamorphic optical elements, i.e., optical elements having different optical power in two axes perpendicular to each other, are typically used for this purpose. Such elements include both reflective (catoptric) and refractive (dioptric) elements.

Such cylindrical or anamorphic optical elements are relatively expensive to produce compared with rotationally symmetrical elements that have the same optical power in each axis. This is particularly true if surfaces are required to have some second or higher order components of curvature. Further, such beam-shaping optical arrangements may be intolerant of the above-discussed manufacturing variations in astigmatism unless designed to be tolerant. Such design adds to the cost and complexity of a system. Refractive optical elements are usually more expensive to manufacture than reflective elements, as two optical surfaces rather than only one must be generated.

There is a need for a beam projecting arrangement that can transform a non-circular astigmatic beam into a circular anastigmatic beam using only a combination of rotationally symmetric optical elements. Preferably, the beam projecting arrangement should not include any refractive optical elements.

### SUMMARY OF THE INVENTION

The present invention is directed to a telescope having a longitudinal optical axis and arranged to receive an astigmatic, input laser-beam. In one aspect of the invention, the telescope comprises a plurality of reflective optical elements, each thereof having a reflective surface that has rotationally symmetric curvature and is inclined at an angle to the optical axis. The reflective surfaces are spaced apart on the optical axis. The curvature of the reflective surfaces, the angle of inclination of the reflective surfaces to the optical axis, and the spacing of the reflective surfaces along the optical axis is selected such that the astigmatic, input laser-beam received by the telescope is projected as an essentially anastigmatic output laser-beam.

The reflective surfaces of at least two of the optical elements must have a non-zero curvature, i.e., a finite radius of curvature. In preferred embodiments of the present invention there are only two of the reflective optical elements. Both of the surfaces may have a concave curvature, or one may have a convex curvature and the other a concave curvature. While spherical surfaces of curvature are preferred for these elements for convenience of manufacture and telescope design, the use of aspheric surfaces, with second or higher order components of curvature is not precluded.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of a beam-shaping telescope in accordance with the present invention including first and second mirrors arranged spaced-apart, and tilted in the same plane with reference to a propagation axis of the telescope.

FIG. 2 is a graph schematically illustrating graphical determination of mirror tilt angles and spacing between first and second mirrors in one example of the telescope having an arrangement similar to the arrangement of FIG. 1.

FIG. 3 is a graph schematically illustrating graphical determination of mirror tilt angles and spacing between first and second mirrors in another example of the inventive telescope having an arrangement similar to the arrangement of FIG. 1.

FIG. 4 is a graph schematically illustrating graphical determination of mirror tilt angles and spacing between first and second mirrors in yet another example of the inventive telescope wherein the first mirror is tilted in a first plane and the second mirror is tilted in a second plane at ninety degrees to the first plane.

FIG. 5A schematically illustrates the first and second mirror arrangement of the example of FIG. 4, seen in a sagittal plane of the second mirror.

FIG. 5B schematically illustrates the first and second mirror arrangement of the example of FIG. 4, seen in a tangential plane of the second mirror.

### DETAILED DESCRIPTION OF THE INVENTION

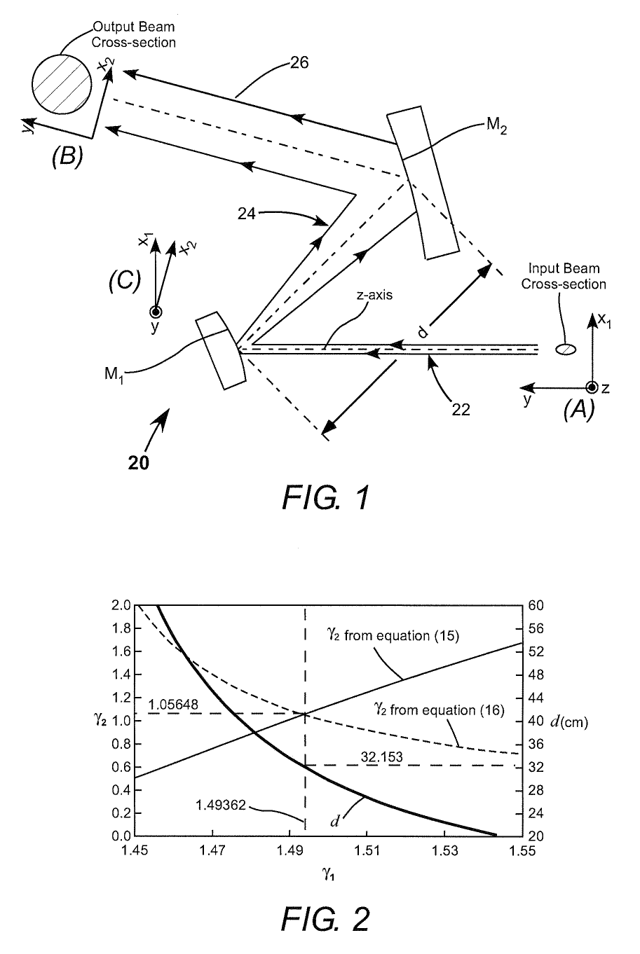

Turning now to the drawings, wherein like features are designated by like reference numerals. FIG. 1 schematically illustrates one preferred embodiment 20 of a beam shaping telescope in accordance with the present invention. A laser beam 22 enters the telescope. Cartesian x- and y-axes (y, x₁) are depicted in graph (A) of FIG. 1. The axis system in graph (A) is rotated 90° about the x-axis to depict the input beam cross-section. In the optical portion of the drawing the y-axis is actually perpendicular to the plane of the drawing with the z-axis (propagation-axis) of the beam illustrated by a dashed line.

Input beam 22 in this example is collimated in the x-z and y-z planes, but is asymmetric in cross-section. The plane of the drawing contains the two vectors (axes) x₁ (for input beam 22) and x₂ (for output beam 26). The cross-section of the input beam is depicted in graph (A) and indicates that the beam is “higher” in the y-axes than in the x-axis wide. The y-axis and x-axis are commonly referred to as the height and width directions, respectively, by practitioners of the optical art.

Input beam 22 is incident first on a convex mirror M₁. Reflection from mirror M₁ transforms the collimated beam into a diverging beam 24. Mirror M₁ is tilted in the plane of the drawing (the tangential plane). Because of this, the mirror has a stronger effect in the plane of the drawing than in the plane perpendicular to the figure (the sagittal plane). Accordingly, the beam diverges more in the tangential plane than in the sagittal plane. This causes diverging beam 24 to grow rounder in cross-section with distance along the z-axis. At a distance d from mirror M₁, a mirror M₂, also tilted in the tangential plane, is used to collimate the beam. Mirror M₂ is concave, and focuses as a positive lens would. The collimated output beam 26 has a round cross-section as indicated in graph (B) of FIG. 1. Graph (C) depicts the tilt of the x₁-axis (the x-axis of input beam 22) relative to the x₂-axis (the x-axis of output beam 26) with the y-axis in the correct orientation.

Because mirror M₂ is tilted in the tangential plane, the mirror has a stronger effect in the plane of the figure (called in this case the tangential plane) than in the plane perpendicular to the figure (called in this case the sagittal plane). As beam 24 is diverging faster in the tangential plane than in the sagittal plane, the tilt angle of mirror M₂ is selected to allow collimation of the beam in both the tangential and sagittal planes. This is achieved with a combination of the angle of incidence on the concave mirror as well as the distance d between the two mirrors. In practice, after the beam has been collimated in both planes by choosing the correct angle of incidence on the concave mirror as well as the correct distance d, the output beam may still be slightly asymmetric. In such a case, the tilt angle of mirror M₁ can be re-adjusted, and the tilt angle of mirror M₂ and distance d can be correspondingly re-adjusted.

Generally, in practice, the astigmatism planes of the input beam may not correspond to the horizontal and vertical planes. In this case, the whole plane of reflections that is depicted in FIG. 1 will need to be adjusted to coincide with the planes of astigmatism. The input beam may also have some divergence, and have a minimum size (beam-waist) which is located at two different locations, one in each plane of astigmatism.

It should also be noted that the two-mirror arrangement of FIG. 1 is not restricted to having a convex first mirror and concave second mirror. The two mirrors may both be concave, or the first mirror may be concave and the second mirror convex. In the latter case, the overall size of the beam is reduced as the beam cross-section is re-shaped.

A particular geometry (tilt angles and distance) for any given mirror pair in the arrangement of FIG. 1 may be calculated using a ray matrix calculation. In a ray-matrix calculation a mirror is represented by a 2×2 (A, B, C, D) matrix wherein:

$$( \begin{matrix}A & B \\ C & D\end{matrix} ) = ( \begin{matrix}1 & 0 \\ - \frac{2 γ}{R} & 1\end{matrix} ) \qquad ( 1 )$$

where R is the radius of curvature (positive for a concave mirror, negative for a convex mirror, infinite for a plane mirror) and γ is given by:

$$γ = \frac{1}{cos ( θ )} for the tangential beam \\ γ = cos ( θ ) for the sagittal beam \qquad ( 2 )$$

and where θ is the tilt angle of the mirror, i.e., the incidence angle of the z-axis on the mirror.

The distance between the beam-waist (the location where the beam has a minimum size) in the first astigmatism plane and the mirror M₁ is defined as L₁. This distance is positive if the beam-waist is located before M₁, and is negative if the beam-waist is located after M₁. The distance between the beam waist in the second astigmatism plane and the first mirror M₁ is defied as L₂. Again, that distance is positive if the beam-waist is located before M₁, and is negative if the beam-waist is located after M₁. Ray matrices for both astigmatism planes:

$$\begin{matrix}( \begin{matrix}{A}_{1} & {B}_{1} \\ {C}_{1} & {D}_{1}\end{matrix} ) = ( \begin{matrix}1 & 0 \\ - \frac{2 {γ}_{2}}{{R}_{2}} & 1\end{matrix} ) ( \begin{matrix}1 & d \\ 0 & 1\end{matrix} ) ( \begin{matrix}1 & 0 \\ - \frac{2 γ}{{R}_{1}} & 1\end{matrix} ) ( \begin{matrix}1 & {L}_{1} \\ 0 & 1\end{matrix} ) & ( 3 ) \\ ( \begin{matrix}{A}_{2} & {B}_{2} \\ {C}_{2} & {D}_{2}\end{matrix} ) = ( \begin{matrix}1 & 0 \\ - \frac{2}{{γ}_{2} {R}_{2}} & 1\end{matrix} ) ( \begin{matrix}1 & d \\ 0 & 1\end{matrix} ) ( \begin{matrix}1 & 0 \\ - \frac{2}{{γ}_{1} {R}_{1}} & 1\end{matrix} ) ( \begin{matrix}1 & {L}_{2} \\ 0 & 1\end{matrix} ) & ( 4 )\end{matrix}$$

where γᵢ is the γ factor for mirror Mᵢ, equal to

$$\frac{1}{cos ( {θ}_{i} )}$$

if mirror Mᵢ is tilted in the first plane of astigmatism. If mirror Mᵢ is tilted in the second plane of astigmatism the γ factor for mirror Mᵢ, equal to cos(θi). In the arrangement of FIG. 1, the first and second planes of astigmatism are respectively the sagittal and tangential planes. Equations (3) and (4) can be developed to obtain:

$$\begin{matrix}( \begin{matrix}{A}_{1} & {B}_{1} \\ {C}_{1} & {D}_{1}\end{matrix} ) = ( \begin{matrix}1 - \frac{2 {γ}_{1} d}{{R}_{1}} & {L}_{1} + d ( 1 - \frac{2 {γ}_{1} {L}_{1}}{{R}_{1}} ) \\ - \frac{2 {γ}_{2}}{{R}_{2}} ( 1 - \frac{2 {γ}_{1} d}{{R}_{1}} ) - \frac{2 {γ}_{1}}{{R}_{1}} & - \frac{2 {γ}_{2}}{{R}_{2}} [ {L}_{1} + d ( 1 - \frac{2 {γ}_{1} {L}_{1}}{{R}_{1}} ) ] + ( 1 - \frac{2 {γ}_{1} {L}_{1}}{{R}_{1}} )\end{matrix} ) & ( 5 ) \\ ( \begin{matrix}{A}_{2} & {B}_{2} \\ {C}_{2} & {D}_{2}\end{matrix} ) = ( \begin{matrix}1 - \frac{2 d}{{γ}_{1} {R}_{1}} & {L}_{2} + d ( 1 - \frac{2 {L}_{2}}{{γ}_{1} {R}_{1}} ) \\ - \frac{2}{{γ}_{2} {R}_{2}} ( 1 - \frac{2 d}{{γ}_{1} {R}_{1}} ) - \frac{2}{{γ}_{1} {R}_{1}} & - \frac{2}{{γ}_{2} {R}_{2}} [ {L}_{2} + d ( 1 - \frac{2 {L}_{2}}{{γ}_{1} {R}_{1}} ) ] + ( 1 - \frac{2 {L}_{2}}{{γ}_{1} {R}_{1}} )\end{matrix} ) & ( 6 )\end{matrix}$$

The complex \tilde{q} parameter for a laser beam is equal to:

$$\tilde{q} = z + j \frac{π {w}_{o}^{2}}{λ} \qquad ( 7 )$$

where wₒ² is the beam-waist size at the 1/e2 points, and z is the distance from that beam-waist, positive if the beam is past its minimum (and is therefore diverging), negative if the beam is before its minimum and is therefore focusing (converging); and λ is the wavelength of the laser beam.

The complex \tilde{q} parameter after the ray matrix

$$( \begin{matrix}A & B \\ C & D\end{matrix} )$$

is given by the following equation:

$${\tilde{q}}_{out} = \frac{A {\tilde{q}}_{in} + B}{C {\tilde{q}}_{in} + D} \qquad ( 8 )$$

where \tilde{q}ᵢₙ is the input parameter, and \tilde{q}ₒᵤₜ is the output parameter. In the instant case, the complex \tilde{q} parameter is different in each astigmatism plane. Since in this case the input is located at exactly the beam-waist, it is known that

$${\tilde{q}}_{in , 1} = j \frac{π {w}_{1}^{2}}{λ} and {\tilde{q}}_{in , 2} = j \frac{π {w}_{2}^{2}}{λ} \cdot {\tilde{q}}_{in , 1}$$

will experience the ray matrix

$$( \begin{matrix}{A}_{1} & {B}_{1} \\ {C}_{1} & {D}_{1}\end{matrix} ) ,$$

and \tilde{q}_{in,2} will experience the ray matrix

$$( \begin{matrix}{A}_{2} & {B}_{2} \\ {C}_{2} & {D}_{2}\end{matrix} ) .$$

The output complex \tilde{q} parameters after the telescope accordingly are:

$$\begin{matrix}{\tilde{q}}_{out , 1} = \frac{{A}_{1} {\tilde{q}}_{in , 1} + {B}_{1}}{{C}_{1} {\tilde{q}}_{in , 1} + {D}_{1}} & ( 9 ) \\ {\tilde{q}}_{out , 2} = \frac{{A}_{2} {\tilde{q}}_{in , 2} + {B}_{2}}{{C}_{2} {\tilde{q}}_{in , 2} + {D}_{2}} & ( 10 )\end{matrix}$$

If the goal is to obtain a collimated and round beam at the output, using equation 7, three equations are provided as follows:
For a collimated output beam in first astigmatism plane:

Re(\tilde{q}_{out,1})=0 (11)

For a collimated output beam in second astigmatism plane:

Re(\tilde{q}_{out,2})=0 (12)

For a round output beam:

$$Im ( \frac{1}{{\tilde{q}}_{out , 1}} ) = Im ( \frac{1}{{\tilde{q}}_{out , 2}} ) \qquad ( 13 )$$

Equation (13) can be rewritten as an equation between d and γ₁:

$${d}^{2} [ \frac{{( 1 - \frac{2 {γ}_{1} {L}_{1}}{{R}_{1}} )}^{2}}{{Z}_{R 1}} - \frac{{( 1 - \frac{2 {L}_{2}}{{γ}_{1} {R}_{1}} )}^{2}}{{Z}_{R 2}} + {( \frac{2 {γ}_{1}}{{R}_{1}} )}^{2} {Z}_{R 1} - {( \frac{2}{{γ}_{1} {R}_{1}} )}^{2} {Z}_{R 2} ] + d [ \frac{2 {L}_{1} ( 1 - \frac{2 {γ}_{1} {L}_{1}}{{R}_{1}} )}{{Z}_{R 1}} - \frac{2 {L}_{2} ( 1 - \frac{2 {L}_{2}}{{γ}_{1} {R}_{1}} )}{{Z}_{R 2}} - \frac{4 {γ}_{1}}{{R}_{1}} {Z}_{R 1} + \frac{4}{{γ}_{1} {R}_{1}} {Z}_{R 2} ] + {Z}_{R 1} - {Z}_{R 2} + \frac{{L}_{1}^{2}}{{Z}_{R 1}} - \frac{{L}_{2}^{2}}{{Z}_{R 2}} = 0 \\ where \\ {Z}_{R 1} = \frac{π {w}_{{o}_{1}}^{2}}{λ} and {Z}_{R 2} = \frac{π {w}_{{o}_{2}}^{2}}{λ} \qquad ( 14 )$$

are the Rayleigh ranges of the beam in the first and the second astigmatism planes, respectively. Equation (14), is a simple second-order polynomial equation in d which can be solved easily for each value of γ₁. Equation (11), in turn may be rewritten as a simple linear equation for γ₂ as a function of d and γ₁, as follows:

$$\frac{2 {γ}_{2}}{{R}_{2}} = \frac{\begin{matrix}[ {L}_{1} + d ( 1 - \frac{2 {γ}_{1} {L}_{1}}{{R}_{1}} ) ] ( 1 - \frac{2 {γ}_{1} {L}_{1}}{{R}_{1}} ) - \\ \frac{2 {γ}_{1}}{{R}_{1}} ( 1 - \frac{2 {γ}_{1} d}{{R}_{1}} ) {Z}_{R 1}^{2}\end{matrix}}{{[ {L}_{1} + d ( 1 - \frac{2 {γ}_{1} {L}_{1}}{{R}_{1}} ) ]}^{2} + {( 1 - \frac{2 {γ}_{1} d}{{R}_{1}} )}^{2} {Z}_{R 1}^{2}} \qquad ( 15 )$$

Equation (12) may be similarly treated to yield:

$$\frac{{R}_{2} {γ}_{2}}{2} = \frac{{[ {L}_{2} + d ( 1 - \frac{2 {L}_{2}}{{γ}_{1} {R}_{1}} ) ]}^{2} + {( 1 - \frac{2 d}{{γ}_{1} {R}_{1}} )}^{2} {Z}_{R 2}^{2}}{\begin{matrix}[ {L}_{2} + d ( 1 - \frac{2 {L}_{2}}{{γ}_{1} {R}_{1}} ) ] ( 1 - \frac{2 {L}_{2}}{{γ}_{1} {R}_{1}} ) - \\ \frac{2}{{γ}_{1} {R}_{1}} ( 1 - \frac{2 d}{{γ}_{1} {R}_{1}} ) {Z}_{R 2}^{2}\end{matrix}} \qquad ( 16 )$$

Equations (14), (15), and (16) are somewhat complex, but can be solved numerically. A simple strategy to find a solution is to choose a value for γ₁ and then find d using equation (14). The solutions for γ₂ can then be calculated from equations (15) and (16). This procedure is iterated until the solutions for both equations (15) and (16) are equal. An exemplary solution for the arrangement of FIG. 1 using this strategy is set forth below.

Here, it is assumed that input beam 22 is collimated, i.e., L₁=0 and L₂=0, and has a beam waist at the input of wₒ_{₁}=500μ along the x₁-direction, and wₒ_{₂}=1000 μm along the y-direction. It is assumed that the laser beam has a wavelength of 1000.0 nanometers (nm), i.e., 1.0 micrometers (μm), in which case the Rayleigh range in each plane will be Z_{R1}=78.54 centimeters (cm) and Z_{R2}=314.16 cm. Mirror M₁ is assumed to be convex with a radius of curvature R₁=−10 cm, and mirror M₂ is assumed to be concave with a radius of curvature R₂=+75 cm.

For γ₁ from 0 to 1.414, both solutions of equation (14) are negative. A negative value of d, however, is not physically possible. For γ₁>1.414, one solution of equation (14) is positive. Solutions for γ₂ as a function of γ₁ from equations (15) and (16) are graphically depicted in FIG. 2. Here γ₁ ranges between 1.45 and 1.55. The two solutions are equal at γ₁=1.49362, where γ₂=1.05648 and d=32.153 cm.

A value of γ₁=1.49362 means that the mirror M₁ is tilted in the tangential plane as depicted in FIG. 1 and that the tilt angle θ₁=47.970°. A value of γ₂=1.05648 means that the second mirror is also tilted in the tangential plane, and that the tilt angle θ₂=18.819°.

In another example of the arrangement of FIG. 1 it is assumed that the input beam has two beam-waists wₒ_{₁} and wₒ_{₂} that are identical and equal to 800.0 μm, but are located at two different locations. The first beam waist is located right at the input of the telescope, i.e., L₁=0. The second beam-waist second is located 2 meters before the telescope i.e., L₂=200 cm. It is again assumed that the laser beam has a wavelength of 1000.0 nm. The Rayleigh range in each plane is identical and equal to 201.06 cm. Again, mirror M₁ is convex with a radius of curvature R₁=−10 cm, and mirror M₂ is concave with a radius of curvature R₂=+75 cm. For γ₁ from 0 to 1.196, both solutions of equation (14) are negative. For γ₁>1.196, one solution of equation (14) is positive.

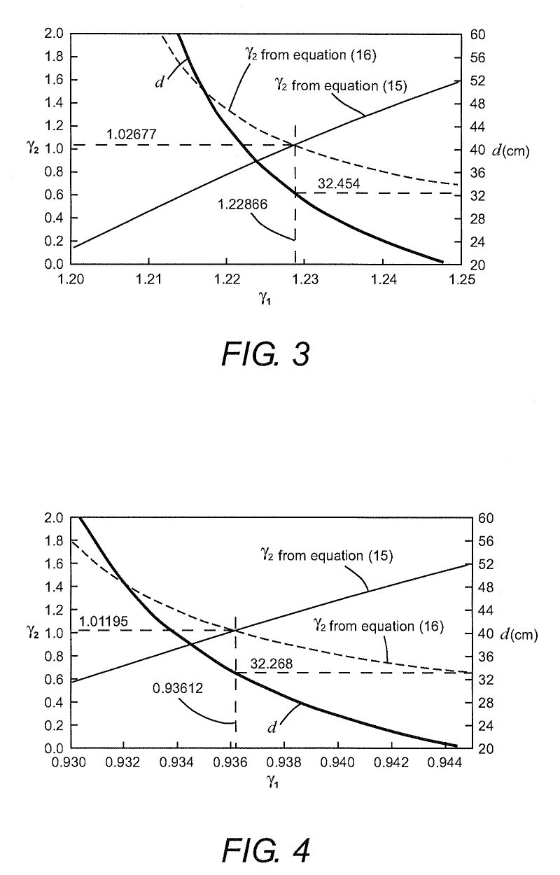

Solutions for γ₂ as a function of γ₁ from equations (15) and (16) are graphically depicted in FIG. 3. Here, γ₁ ranges between 1.20 and 1.25. The two solutions are equal at γ₁=1.22866, where γ₂=1.02677 and d=32.454 cm. A value of γ₁=1.22866 means that mirror M₁ is tilted in the tangential plane and that θ₁=35.522°. A value of γ₂=1.02677 means that the mirror M₂ is also tilted in tangential plane, and that θ₂=13.112°.

In yet another example of the inventive telescope it is assumed that the input beam has both a severe astigmatism and asymmetry. It is assumed that the beam-waists of the input beam are wₒ_{₁}=50 μm along the x₁ direction, and wₒ_{₂}=1000 μm along the y direction. The beam-waists are assumed to be located at two different locations. The first beam-waist is located 13 cm before the input of the telescope, i.e., L₁=13 cm. The second beam-waist is located at the input of the telescope, i.e., L₂=0° It is yet again assumed that the laser beam has a wavelength of 1000 nm. The Rayleigh range is Z_{R1}=0.785 cm along the x₁ direction, and Z_{R1}=314.16 cm along the y direction. Yet again, mirror M₁ is assumed to be convex with a radius of curvature R₁=−10 cm, and mirror M₂ is assumed to be concave with a radius of curvature R₂=+75 cm.

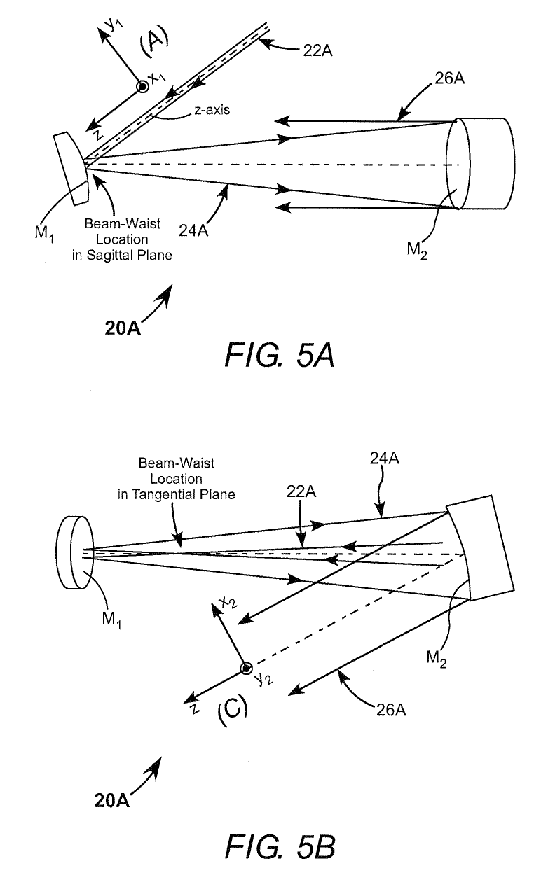

For values of γ₁ below 0.923, both solutions of equation 14 are negative. For γ₁>0.923, one solution of equation 14 is positive. Solutions for γ₂ as a function of γ₁ from equations (15) and (16) are graphically depicted in FIG. 4. Here, γ₁ ranges between 0.930 and about 0.945. The two solutions are equal at γ₁=0.93612 with γ₂=1.01195 and d=33.268 cm. A value of γ₁=0.93612 means that mirror M₁ is tilted in the sagittal plane and that θ₁=20.591°. A value of γ₂=1.01195 means that mirror M₂ is tilted in tangential plane, and that θ₂=8.814°. In this example, schematically depicted in FIG. 5A and FIG. 5B as telescope 20A both mirrors M₁ and M₂ are tilted in different planes and accordingly the output beam does not remain co-planar with the input beam as in the arrangement of FIG. 1.

FIG. 5A is view of telescope 20A in the sagittal plane of the output beam. FIG. 5B is view of telescope 20A in the tangential plane of the output beam. The x-, y- and z-axes, graphs (A) and (C), are depicted in the correct location, i.e., the axes are not rotated to illustrate the beam cross-section. The input beam is designated as beam 22A. The input beam is depicted as essentially collimated in the sagittal plane with a beam waist assumed to be on mirror M₁. In the tangential plane there is a much narrower beam-waist ahead of mirror M₁ as discussed above with reference to the example of FIG. 4. The diverging beam between the mirrors is designated as beam 24A; and the collimated (in both astigmatism planes) output beam is designated as beam 26A. This geometry depicted in FIGS. 5A and 5B is not as desirable as the geometry of FIG. 1, as the output beam is out of plane with the input beam in both x and y directions when the beam exits the telescope and may need several reflections from different mirrors to be redirected as desired.

An experimental example of the inventive beam-shaping and astigmatism correcting telescope was constructed to expand and correct a beam from a titanium-doped sapphire solid-state laser. The laser beam before expansion had astigmatism of 1.01 and asymmetry of 1.13. An ideal beam would have zero astigmatism and an asymmetry of 1.0. The astigmatism and asymmetry were measured on a commercially available M₂-meter.

In the experimental telescope, configured generally as depicted in FIG. 1, convex mirror M₁ has a radius of curvature R₁=−10 cm, and concave mirror M₂ has a radius of curvature R₂=+75 cm. Both mirrors were tilted in the plane of the laser. The angle of incidence θ₁ on convex mirror M₁ is about 35.0°. The angle of incidence θ₂ on concave mirror M₂ is about 12.6°. The mirror separation d was set around 32.6 cm. The resulting beam output beam had a diameter of about 6.5 millimeter (mm) diameter, and the astigmatism and asymmetry was greatly reduced compared with the astigmatism and asymmetry of the input beam. In a typical measurement, the output beam had astigmatism of about 0.03, i.e., close to zero, or essentially anastigmatic, and perfect asymmetry, i.e., an asymmetry of 1.0.

It should be noted in examples of the inventive telescope discussed above only two mirrors, each thereof having a finite (positive or negative), rotationally symmetric radius of curvature, are used to achieve beam shaping and astigmatism correction. Those skilled in the art will recognize that similar results may be achieved using three of more mirrors having finite radius of curvature. The calculation of mirror radii and spacings may be anticipated to be somewhat more complex than in the case where only two such mirrors are used.

In summary, the present invention is described above with reference to a preferred and other embodiments. The invention, however, is not limited to the embodiments described and depicted. Rather, the invention is limited only by the claims appended hereto.

What is claimed is:

1. A telescope for receiving an astigmatic input laser-beam, the telescope having a longitudinal optical axis, and comprising:
a plurality of reflective optical elements each thereof having a reflective surface that has rotationally symmetric curvature and is inclined at an angle to the optical axis, with the reflective surfaces being spaced apart on the optical axis; and
wherein the curvature of the reflective surfaces, the angle of inclination of the reflective surfaces to the optical axis, and the spacing of the reflective surfaces along the optical axis is selected such that the astigmatic input laser-beam received by the telescope is projected as an essentially anastigmatic output laser-beam.

2. The telescope of claim 1, wherein the input laser-beam has a non-circular cross-section, and the curvature of the reflective surfaces, the angle of inclination of the reflective surfaces to the optical axis, and the spacing of the reflective surfaces along the optical axis is further selected such that the anastigmatic output laser-beam has a circular cross-section.

3. The telescope of claim 2, wherein there are only first and second reflective optical elements, and the input laser beam is incident first on the first optical element.

4. The telescope of claim 3, wherein the reflective surface of the first reflective optical element has a convex curvature, and reflective surface of the second reflective optical element has a concave curvature.

5. The telescope of claim 4, wherein the first and second reflective optical elements are tilted in the same plane with respect to the optical axis.

6. The telescope of claim 4, wherein the first and second reflective optical elements are tilted in respectively first and second planes with respect to the optical axis with the first and second planes being at angle to each other.

7. The telescope of claim 6, wherein the first and second planes are at ninety degrees to each other.

8. The telescope of claim 1, wherein the curvature of the reflective surfaces, the angle of inclination of the reflective surfaces to the optical axis, and the spacing of the reflective surfaces along the optical axis is further selected such that the telescope functions as a beam-expander for the input laser-beam.

9. A telescope for receiving an astigmatic input laser-beam having a non-circular cross-section, the telescope having a longitudinal optical axis, and comprising:
a first and second reflective optical elements each thereof having a reflective surface that has rotationally-symmetric, finite radius of curvature and being inclined non-orthogonally to the optical axis, the reflective surfaces being spaced apart on the optical axis, and the input beam being incident first on the reflective surface of the first reflective optical element;
the reflective surface of the first reflective optical element having a convex radius of curvature, and the reflective surface of the second reflective optical element having a concave radius of curvature; and
wherein the curvature of the reflective surfaces, the inclination of the reflective surfaces to the optical axis, and the spacing of the reflective surfaces along the optical axis is selected such that the astigmatic input laser-beam received by the telescope is caused by the reflective surface of the first optical element to diverge in first and second planes at ninety degrees to each other onto the reflective surface of the second reflective optical element, and such that the diverging beam is reflected from the reflective surface of the second optical element as an essentially collimated, essentially anastigmatic, output laser-beam having an about circular cross-section.

10. The telescope of claim 9, wherein the first and second reflective optical elements are each tilted in the first plane with respect to the optical axis.

11. The telescope of claim 9, wherein the first and second reflective optical elements are tilted in respectively the second and first planes with respect to the optical axis.

12. A method of correcting the astigmatism of a laser beam having a non-circular cross section comprising the steps of:
directing the beam to a first reflective optical element having a rotationally symmetric radius of curvature, said first element being inclined non-orthogonally to the optical axis of the beam; and
after reflection from the first optical element directing the beam to a second reflective optical element having a rotationally symmetric radius of curvature, said second element being inclined non-orthogonally to the optical axis of the beam, said optical elements being arranged such that beam, upon reflection from the second optical element is essentially collimated, essentially anastigmatic and has essentially a circular cross-section.

13. A method as recited in claim 12, wherein said first optical element has a convex curvature and said second optical element has a concave curvature.
